(19) United States
(12) Patent Application Publication
(10) Pub. No.: US 2016/0182466 A1
(43) Pub. Date: Jun. 23, 2016

(54) TransDRM for Streaming Media

(71) Applicants: Arjen Wagenaar, Amsterdam (NL); Dirk Griffioen, Arnhem (NL)

(72) Inventors: Arjen Wagenaar, Amsterdam (NL); Dirk Griffioen, Arnhem (NL)

(73) Assignee: CodeShop BV, Amsterdam (NL)

(21) Appl. No.: 14/938,865

(22) Filed: Nov. 12, 2015

Related U.S. Application Data
(60) Provisional application No. 62/095,812, filed on Dec. 23, 2014.

(51) Int. Cl. H04L 29/06

(52) U.S. Cl. CPC H04L 63/0457; H04L 63/0876; H04L 63/0464

(57) ABSTRACT

A method for trans-muxing media content into various consumption formats in a content delivery network, the method comprising the steps of reading a server manifest file, dynamically re-encrypting the media content from the at least one DRM setting into one or more re-encrypted DRM formats, and updating the server manifest file to identify a trans-mux support of the one or more re-encrypted DRM formats. The server manifest file can include a key id and a content encryption key that authorize a re-encrypting of media content, and at least one Digital Rights Management (DRM) setting identifying a source of media content. Other embodiments are disclosed.

### CROSS-REFERENCE TO RELATED APPLICATIONS

This application claims the priority benefit of U.S. Provisional Patent Application No. 62/095,812 entitled “TransDRM for Streaming Media” filed Dec. 23, 2014, of the same inventors, the entire contents of which is hereby incorporated by reference including appendices.

### FIELD

The embodiments herein relate generally to content delivery and streaming over the Internet, and more particularly to, trans-muxing of media formats in real-time streaming of media content.

### BACKGROUND

Adaptive bit-rate streaming (ABR) is an established technique used in streaming multimedia over computer networks and communication devices. Video streaming technologies utilizing ABR protocols are mostly based on HTTP and designed to work efficiently over large distributed HTTP networks such as the Internet. ABR streaming is a method of video streaming over HTTP where the source content is encoded at multiple bit rates, then each of the different bit rate streams are segmented into small multi-second parts. The streaming client is made aware of the available streams at differing bit rates, and segments of the streams by a manifest file.

Multimedia conveyed over the internet using ABR can be encrypted to protect it from unauthorized access or use. Encryption is a way of protecting the media with a unique content identifier for providing data security. Information about the type of protection is generally included in a manifest file, and which also provides information for retrieving the media. In order to access the encrypted media, end users acquire a license key that allows for decryption and playback. Without this license key, encrypted media will not play.

Often, content owners require their content to be encrypted using an approved Digital Rights Management (DRM) system. DRM in comparison to the previously mentioned encryption differs in that it adds a secure key-exchange between livense server and client. Next to in the clear, the content may also exist encrypted on disk and can be sent to viewers only in the format as on disk by the service provider. FIG. 1 illustrates a situation where an origin 110 maintains encrypted content 111 in a certain format A and which is provided to the viewer 130 on request. The information in the manifest file identifies the encryption, and provides authorization and a location to retrieve the media. This situation suffices when the viewer 130 is able to interpret and present the encrypted content 111 in the provided format A. However, when the service provider wants to stream the content with another DRM system in another format B, the content has to be repackaged in full and reside as a second copy on the storage system—which in large content portfolios, may be cost prohibitive.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a standard situation for content delivery of encrypted media;

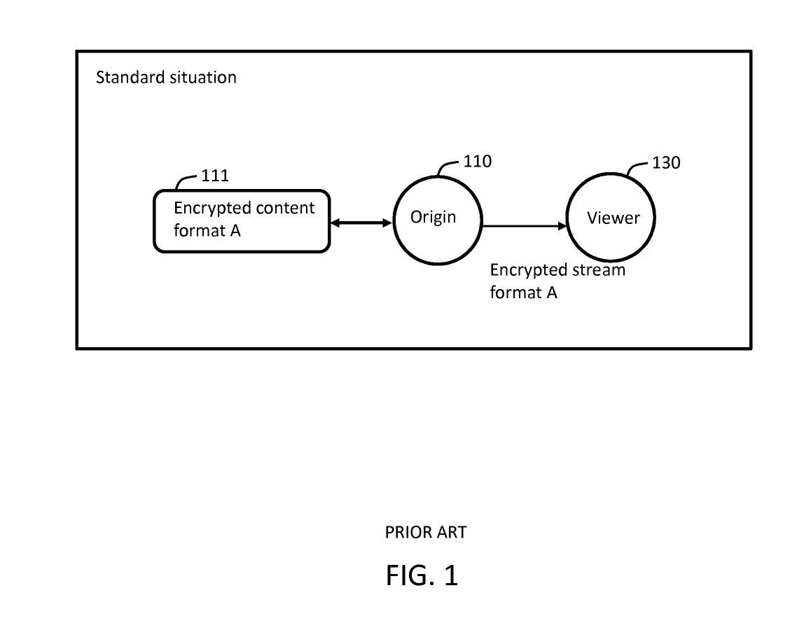

FIG. 2A is an exemplary system enhanced with dynamic re-encryption using a local server manifest in accordance with one embodiment;

FIG. 2B is an exemplary system enhanced with dynamic re-encryption using a dynamically fetched server manifest in accordance with one embodiment;

FIG. 3A depicts a key value pair for trans DRM in accordance with one embodiment;

FIG. 3B depicts a command line too for trans DRM in accordance with one embodiment;

FIG. 3C depicts an exemplary server manifest file in accordance with one embodiment;

FIG. 4A depicts a system for dynamic re-encryption in accordance with one embodiment;

FIG. 4B illustrates a flow chart for dynamic re-encryption in accordance with one embodiment; and

FIG. 5 is a diagrammatic representation of a machine in the form of a computer system within which a set of instructions, when executed, may cause the machine to perform any one or more of the methodologies discussed herein.

### DETAILED DESCRIPTION

Herein provided is a method and system to dynamically re-encrypt media content suitable for use with DRM/encryption systems. Dynamic re-encryption (or ‘trans DRM’) solves the challenge of having to maintain media content in a variety of encryption formats: one format may suffice. It can also keep storage cost manageable while providing flexibility in terms of support and integration with existing DRM/encryption systems. Dynamic re-encryption is performed on an already encrypted piece of content (from the content provider's perspective), employing different DRM systems simultaneously, for instance, where the content can be stored in DRM A and presented to the viewer in DRM B, and where the configuration may change dynamically as well.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

Briefly, the terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “streaming”, “streaming media”, and “streaming media protocol” are intended to broadly encompass any media program or protocol including at least digital video and/or digital audio content which can be rendered and played by a rendering device at the receiving end of one or more wired or wireless data connections. Streaming media or streaming media programs can be audio programs and/or music, video on demand programs, linear video programs, live video programs or interactive programs and can be transported through the data network in any suitable manner as will occur to those of skill in the art. The term “viewer” is intended to mean in one case a person that receives or provides user feedback and in another case a device or electronic communication display that visually presents information which the person views. The term “player” is intended to mean a software program or device that visually presents or exposes media with or without media functionality or interaction to a viewer/person. The term “processing” can be defined as number of suitable processors, controllers, units, or the like that carry out a pre-programmed or programmed set of instructions. The terms “program” and “method” are intended to broadly mean a sequence of instructions or events for the performance of a task, which may be executed on a machine, processor or device. The term “mux” means a type of multiplexing specific to media formatting that sends multiple streams of multimedia simultaneously, for example, by way of one or more DRM's.

The term “Content Management System” (CMS) is intended to mean a computer application and repository for multimedia, video, audio, documents, and related data, along with metadata, that allows users to process and work with the above content or media. The term “origin” is intended to mean a computer server that communicatively interfaces to a viewer and sources media to the viewer, and that interfaces with a content management server to provide media content via one or more digital rights management systems. The term “Digital Rights Management” (DRM) means broadly a class of technologies that are used by hardware manufacturers, publishers, copyright holders, and individuals with the intent to control the use of digital content and devices after sale. The term “content delivery network” includes one or more system components such as a CMS server, DRM server and/or origin, that when communicatively coupled provide for delivery and streaming of media content. The term “local” is intended to mean information associated at a particular locale, for example, locally on a server; or, with a user (person), user device or service, for example, geographic location of the user, or geographic location of an advertised service or event, or other information including but not limited to business identifier, network identifier, mobile device identifier, or logon profile. The term “encryption” means the conversion of electronic data into another form, called ciphertext, which cannot be easily understood by anyone except authorized parties. The term “decryption” means the process of converting encrypted data back into its original form, so it can be understood.

Also as used herein, the term “URL” stands for Uniform Resource Locator, and is a means to specify addresses on the World Wide Web; it is the fundamental network identification for any resource connected to the web (e.g., hypertext pages, images, and sound files). The term “URI” is meant to broadly include any suitable method of identifying data available for access through a network, such as the URIs defined in the IETF RFC3986 “Uniform Resource Identifier (URI): Generic Syntax”, or any other suitable mechanism, system or method for identifying such data. The term header is meant to broadly include any suitable method or object identifying a type or format of media content, such as origin headers in IETF RFC 5988. Furthermore, as used herein the term “inserted content” and/or “dynamically inserted content” is intended to comprise any media content, video and/or audio, which it is desired to insert into a streaming media program. While the most common example of inserted content may be advertising programming, it is also contemplated that other content can be inserted, if desired, and such inserted content can include: alternate endings to streaming media programs; substitution of program durations with other programs or black screens such as for sports “blackouts”; changes to scenes or portions of scenes within a streaming media program; TV-like “channel surfing” through available streaming media programs, live or on demand, where the inserted content is the streaming media program on the channel the user switches to; etc. Further, inserted content can be overlay content displayed or played in combination with the main program.

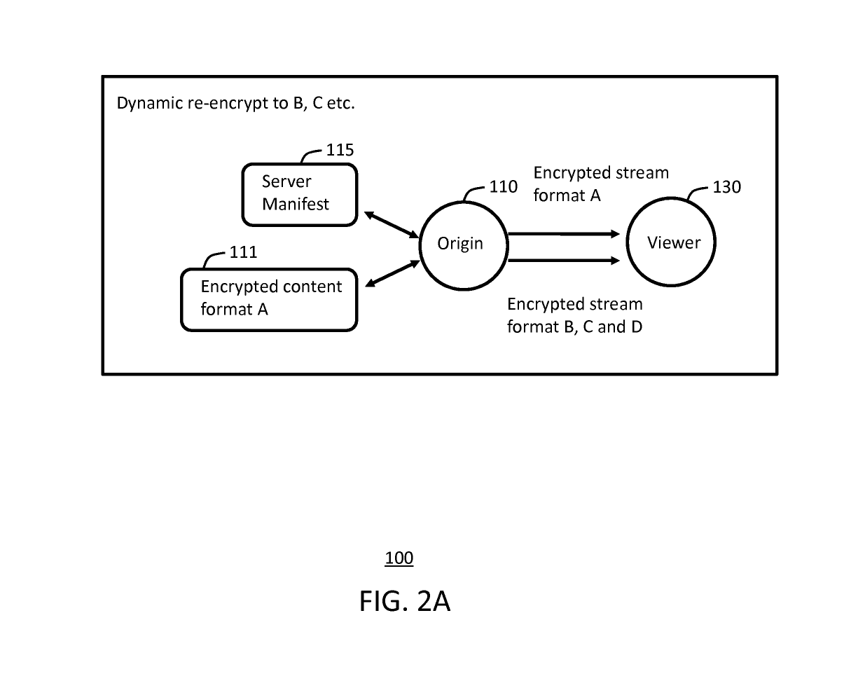

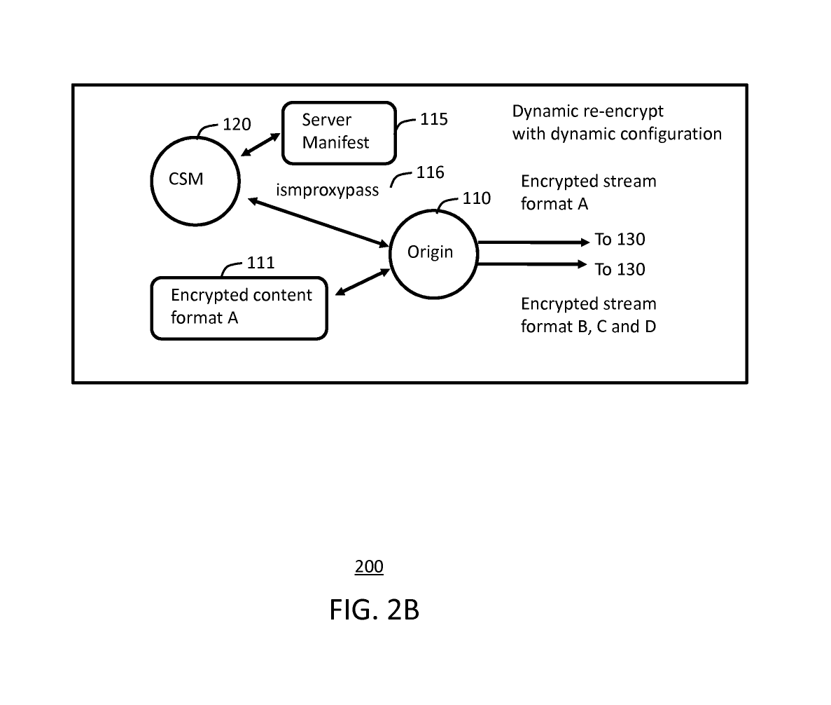

FIG. 2A depicts components of a system 100 for dynamic re-encryption suitable for use in a content delivery network—where a server manifest is generated locally—in accordance with a first embodiment. The system 100 includes an origin 110, and indirectly a viewer 130. The origin 110 provides media content responsive to a request from the viewer 130, for example, to play media such as video on demand or live streaming. In one case, the origin 110 may be required to determine what media formats are supported by the viewer 130 from the request. In another case, the viewer 130 may provide indication of what media formats it requires for consumption. In either case, as disclosed herein, the media content is provided in the desired format so the viewer 130 can properly present it.

The origin 110 upon receiving a request from the viewer 130 for media content reads the server manifest file 115 to determine what media is available for streaming and where to source the media (either locally or from other web sites). The server manifest 115 includes security keys and content related keys that provide authorization for retrieving the media and performing operations on the media as required for preparing and streaming to the viewer 130, in particular, encrypting and decrypting. If the requested media content is in the required media format and available at the origin 110, the origin 110 streams the encrypted (or decrypted) media content 111 to the viewer 130. If not, the origin 100 reads the server manifest 115 to determine which media formats the origin 110 can trans-mux to and make available in other media formats (including various bit-rates, packet sizes, timing etc), and which are i) locally available, or ii) which may be available elsewhere, as specified in the server manifest 115.

In the first case, (i), trans-coded media that resides locally at the origin 110 can be streamed from the origin 110. Alternatively, in case (ii), the server manifest 115 identifies DRM settings (e.g., parameters, data, links) that indicate where the media can be retrieved. The origin 110 can thus retrieve the media from one or more remote DRM's to fulfill the streaming request for the viewer 130. In this second case, the origin 110, instead of directly presenting the content to the viewer 130 in the original encryption form, chooses a format in accordance with the required viewer format which is applied dynamically in responding to the request.

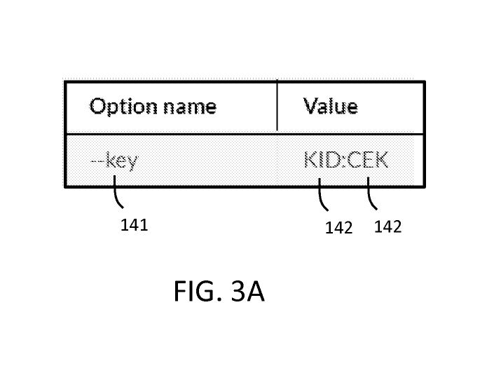

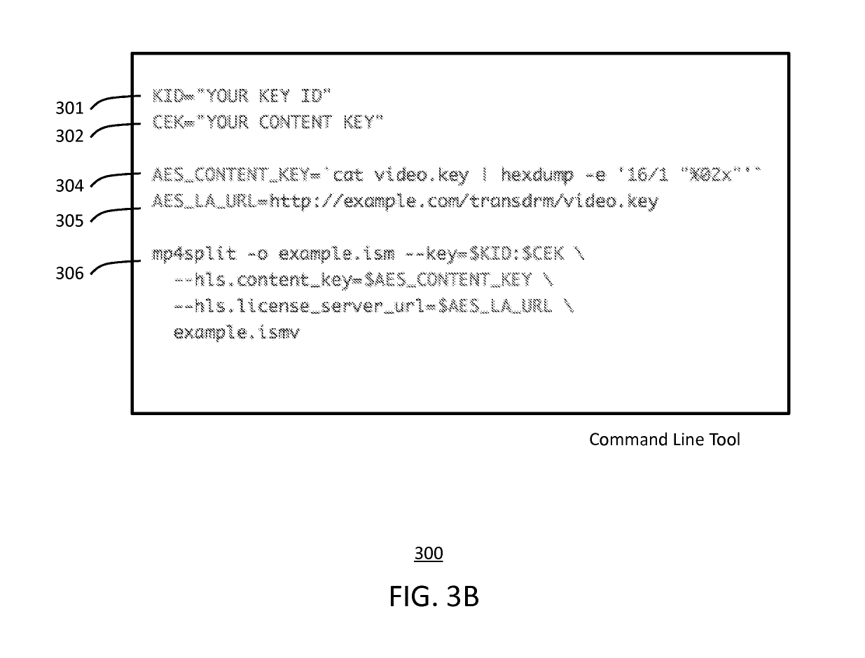

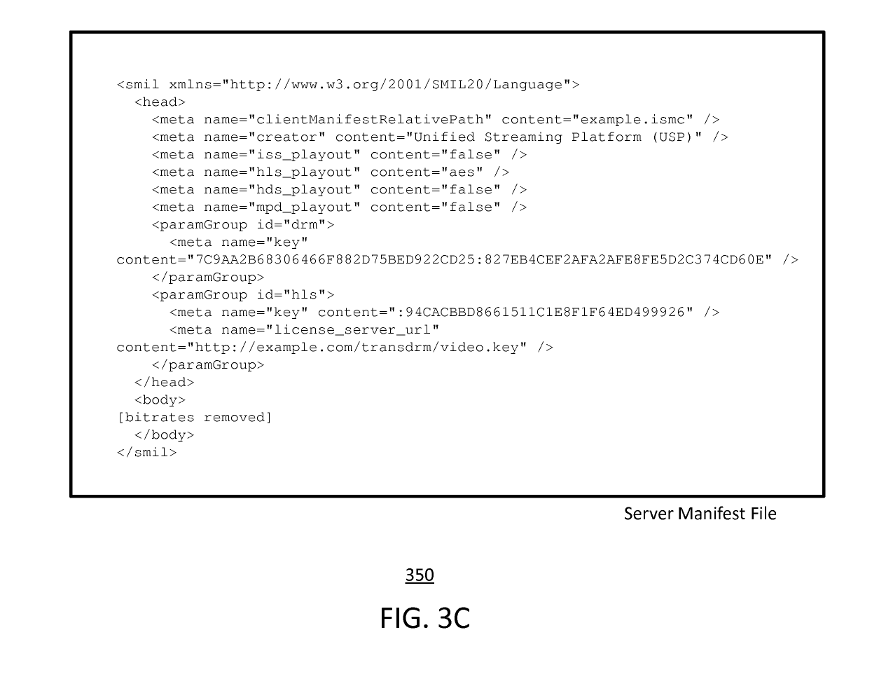

FIG. 3A shows an exemplary key value pair for the parameters used by the server manifest 115; namely, the key option 141, the key id 142 and the content encryption key 143. In the first embodiment (where the server manifest 115 is stored and read local), the origin 110 creates (or updates) the server manifest 115 using a key identifier (KID) and a content encryption key (CEK) for original media content. This allows the origin 110 to re-encrypt media content to support other formats. For decryption, only the KID and CEK parameters are required. The origin 110 can do this via an origin configuration tool used to create the server manifest 115, for example, via a command line discussed ahead. The origin configuration tool creates the server manifest 115 used by the origin to stream (so it can read the original key, decrypt and re-encrypt with the new/other keys listed in the server manifest). In this first configuration, the server manifest 115 will reside locally on the origin 110, so when, new requests come in, the origin 110 can retrieve the content in view of the server manifest 115, and provide for various re-encrypted supported formats required by the viewer 130.

FIG. 3B shows a command line tool 300 using parameters from the key value pair in FIG. 3A for generating the server manifest. Both elements are clearly visible: kid:cek and the DRM to encrypt to (AES-128 for HLS). The command line tool 300 includes indication of the key identifier (KID) 301 and the content key (CEK) 302. These parameters are encapsulated in the resulting server manifest file to provide for the authorized use or license to the media content, whether local or retrieved via the one or more DRM's, that is streamed to the origin 110 and ultimately the viewer 130 for consumption. The command line tool 300 includes for indication of the encrypted type by way of the content key (e.g., AES_CONTENT_KEY; where AES is the type of encryption) 304 and the encrypted license acquisition address (e.g., AES_LA_URL). The LA_URL is used for encryption, it is not necessary for decryption. The command line tool 300 generates the resulting server manifest file through a command line utility 306 (e.g., “mp4split”; build tool including compilation and linking) which encapsulates the parameters (301-305) in the server manifest.

FIG. 3C, illustrates an exemplary server manifest file 350 created by the command line tool 300 shown in FIG. 3B. Understandably, other parameters may be included by the command line tool 300 for the generation of the server manifest 350. The command line tool parameters are encapsulated in the body of the server manifest 350. Namely, the server manifest 115 holds information about the available streams, for example, DRM options, license keys, content keys, and other information; including, where to retrieve the media content (e.g., via URL) and what format the media content is in at that location. The origin 110 uses the information in the server manifest file 115 for creating different client manifests/playlists and applying any selected encryption. In this way, the origin 110 can dynamically re-encrypt an already encrypted piece of content (from the perspective of the content provider who is providing it in only one format), employing different DRM systems simultaneously to support the transcoded media format, where the content may in stored in DRM A and presented to the viewer in DRM B where the configuration may change dynamically as well.

FIG. 2B depicts components of the system 200 for dynamic re-encryption suitable for use in a content delivery network—where a server manifest is dynamically fetched from a Configuration Management System (CMS)—in accordance with a second embodiment. In this second configuration, the origin 110 retrieves the server manifest 115 from the CMS 120 by including an ismproxypass keyword to identify the location of the server manifest 115 at the CMS 120 in the request. In one arrangement, the origin 110, by way of a Unified Origin (see APPENDIX B, C and D Unified VOD, Live and DRM together form Unified Origin) fetches the server manifest 115 with the required options (e.g., keys for encrypting/decrypting content at DRMs) from a secure location (e.g., CMS 120) by using the ismproxypass keyword effectively telling the origin 110 where to fetch the server manifest 115 for a certain request. (See also APPENDIX D “Unified DRM”.)

Fetching the server manifest file 115 from the CMS 120 is a secure methodology when data on a locally stored system providing the server manifest (e.g., on disk at the origin 110) is unsecure or may be compromised. This may be the case also when content providers (e.g., broadcasters) want to ensure and manage the security of their content, for example, by controlling oversight and use of certificates, key and rights included or identified in the server manifest file 115 on the CMS 120. The fetching is dynamic in the sense that the mapping created from the ismproxypass fetches the server manifest 115 from the location as it is needed. For instance, responsive to a request from a client that triggers a fetch of the server manifest 115. The returned server manifest 115 then can be same or different, based on implemented business rules in the CMS 120. For example, the server manifest fetched may be dynamically updated by the CMS to identify different DRM's (listed in the server manifest) which the origin 110 can retrieve the encrypted content as it is streaming media. Alternatively, the CMS business rule may indicate no DRMs are to be used thereby requiring the origin 100 to stream the media in the clear (no encryption), or alternatively, the CMS 120 can update the list of different DRMs for the origin 110 to retrieve encrypted media.

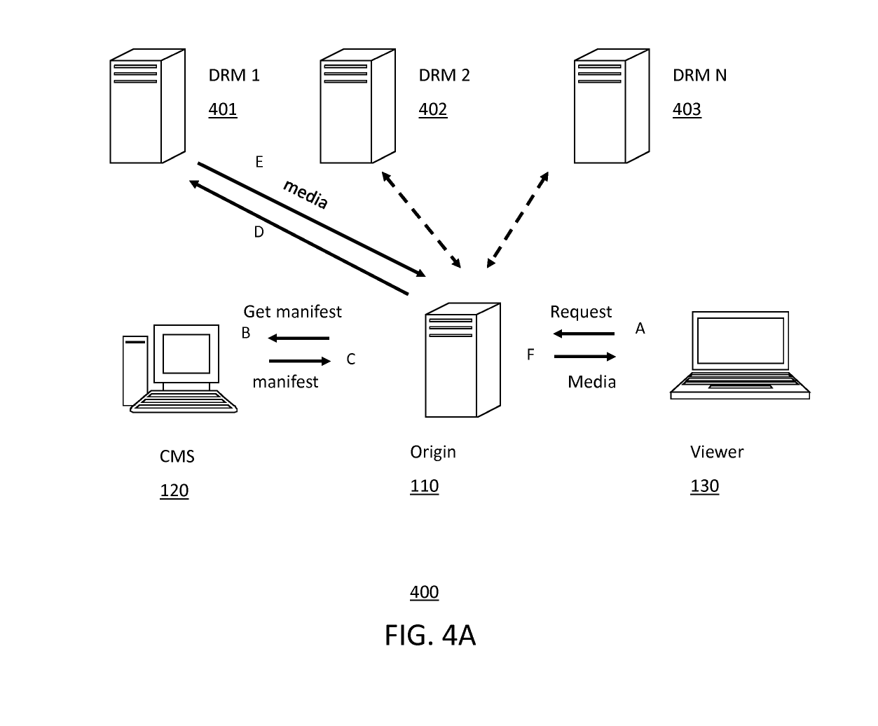

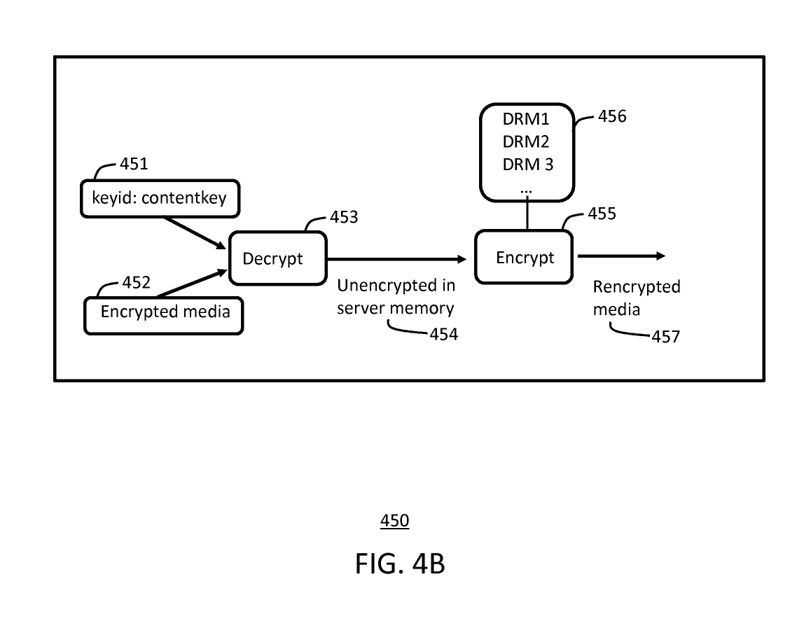

In this second configuration, the server manifest 115 is fetched for each request from the origin 110, and thus can change, or be changed by the CMS 120. It is also dynamic in two aspects a) the server manifest 115 is fetched each time by the origin 110; that is, it is not static on disk and local at the origin 110, and b) the CMS 120 can change the server manifest 115 for each request determined by business rules in the CMS 120, for instance, by updating or adding DRM settings, such as http links and access parameters, for the origin 110 to retrieve encrypted content only from certain providers for permitted streaming, or supporting of particular media formats. For example, consider a broadcaster that has a paid service where a customer can watch the show's episode on the internet before it becomes generally available on TV. After it has aired and run its course, the broadcaster can specify to the CMS 120 a rule that the episode is no longer under DRM obligations and a viewer 130 may view it in the clear (without encryption). The CMS 120 will update the server manifest 115 to remove the previous DRM settings (e.g., links, parameters) as configured by its business logic/rules (e.g., set the date after which no DRM applies etc.). That is, the CMS updates the server manifest 115 such that, the next day when the episode is not be under DRM requirements, it does not include any DRM settings, and so, the origin 110 upon requesting the server manifest 115 will determine that there are no DRM settings, thus permitting the origin 110 to stream the content to the viewer thereby bypassing DRM providers in support of the business rules. Similarly, if the broadcaster at a later date decides to update to a lower quality media format or data rate, and desires to encrypt the media and assign certain viewing rights, it can inform the CMS 120 of such intent or rules, at which time, the CMS 120 will thereafter identify a DRM (e.g. 401-406; see FIG. 4A) to stream the encrypted content and add/include links within the server manifest 115 such that the origin 110 upon requesting the newer media content will be directed by way of the DRM settings in the server manifest 115 from which to stream the newer media.

The server manifest file 115 can be provided in two forms: 1) a server manifest filename ending with the extension .ism is used for VOD presentations, and 2) a server manifest filename with an extension of .isml (additional character ‘I’ for live) for LIVE presentation. More information is provided in Appendix C “Unified LIVE” herein incorporated by reference in entirety. The basic form the command for creating a VOD server manifest file is:
mp4split -o/var/www/oceans/oceans.ism/var/www/oceans/oceans.ismv
   Multiple input filenames can also be specified. For example, given the audio track in oceans-64k.isma and two video files, oceans-512k.ismv and oceans-800k.ismv:

mp4split -o /var/www/oceans/oceans.ism \

```
  /var/www/oceans/oceans-64k.ismv \
  /var/www/oceans/oceans-512k.ismv \
  /var/www/oceans/oceans-800k.ismv
```

The video files do not necessarily have to be stored locally. The origin 110 is also able to fetch the media data from any HTTP server (e.g. S3, Azure) on specification of the input files using fully qualified URLs:

mp4split -o /var/www/oceans/oceans.ism \

http://storage.server/oceans/oceans-64k.ismv \
http://storage.server/oceans/oceans-512k.ismv \
http://storage.server/oceans/oceans-800k.ismv

When using an encoder (Expression Encoder, Digital Rapids, Envivio, etc.) for producing VOD smooth streaming presentations, it is always necessary to re-create the server manifest file (.ism). USP stores additional information in the server manifest file which may not be available in the server manifest file generated by the encoder. It is not necessary to create the playlists (.ismc, .m3u8, .mpd, .f4m). All these files are created on demand or request by the webserver module.

FIG. 4A depicts a system 400 for dynamic re-encryption in accordance with one embodiment. It illustrates a broader implementation of the two system embodiments shown in FIG. 2A and FIG. 2B. The system 400 includes the origin 110, the CMS 120, one or more DRM's (401-403), and the viewer 130. A sequence of arrows with alphabet letters (A-E) is overlaid for pointing out the sequence of method steps involved and previously discussed in FIG. 2A and FIG. 2B. When discussing the method steps, reference will be made to the other figures for previously provided information and including FIG. 4B, which illustrates a flow chart 450 for dynamic re-encryption in accordance with one embodiment. It should be noted that the method steps may include more or less than the number of steps shown, for example, depending on a specific configuration, for instance, whether the server manifest is read local at the origin 110 or dynamically fetched from the CMS 120.

At step A, the viewer 130 requests media content from the origin 110. The origin 110, upon receiving the request for media content from the viewer 130, reads the server manifest file 115 (also 350) to determine how to fulfill the request. As previously noted, the server manifest can reside locally on the origin (thereby reading it locally), or it can be dynamically fetched from the Content Management Server (CMS) 130 and returned for reading as shown in steps B and C respectively. Recall, the server manifest 115 holds information about the available streams, for example, DRM options, license keys, content keys, and other information; namely, where to retrieve the media content (e.g., via URL to the one or more DRM's 401-406) and what format the media content is in at that location. The origin 110 uses the information in the server manifest file 115 for creating different client manifests/playlists and applying any selected encryption.

If the server manifest 115 indicates that the origin should retrieve re-encrypted media content from a DRM, the origin 110 provides the security and content keys to the DRM 401 for authorized access to the encrypted media at step D, and retrieves the re-encrypted media content from the respective DRM (as shown; 401) as shown in step E. If however, the server manifest 115 indicates a media format which the origin 110 already supports, the origin 110 can deliver the media content locally from its storage. The origin 110 delivers the requested media content to the viewer 130 as show in step F.

In certain other situations, the server manifest 115 from the CMS 120 may indirectly instruct (by virtue of, or lack of, the parameters contained in the server manifest) the origin 110 to decrypt and then re-encrypt the media according to specification of another DRM. This is the case, when the origin 110 does not have, or cannot provide, the media in the requested media format, or the existing DRM's do not have the media in the requested format for the origin 110 to retrieve. If a new DRM is needed, the CMS 120 will be configured to return both the original key (to decrypt) and a new one (according to the specs of the other DRM) to encrypt with. The required change in the business logic to support a new DRM may be implemented separately by request to the CMS, or in response to the origin 110 indicating that the requested media format is not available as expressed by its reading of the server manifest 115. In this manner, the origin 110 upon receiving the original key and specs, can decrypt media from a first DRM storing the original media, and then re-encrypt in accordance with specifications for a second DRM for storage and later retrieval at the second DRM.

FIG. 4B illustrates a flow-chart 450 for dynamic re-encryption in support of FIG. 4A. The origin 110 upon reading the server manifest 115 and extracting the key access parameters 451 (keyid, contentkey) and retrieving the encrypted media 452 (either locally at the origin, or, from a DRM 401-406; see FIG. 4A), decrypts the encrypted media at element 453 to produce unencrypted media 454 in the clear at the server memory (i.e., memory in origin 110). The origin 110 then uses the new key information provided in the key access parameters for the new DRM (which will host the new formatted media) to encrypt at element 455 the media 454 in the clear into a format supported by the new DRM 456, and which is thereafter stored on the new DRM. The re-encrypted media 457 in the new format (and, corresponding to the media format required to fulfill the request) is then provided to the viewer 130.

The primary purpose of the encryption 455 is to protect the confidentiality of the digital media stored on computer systems (e.g., CMS 120, and origin 110; FIG. 4A) or transmitted via the Internet or other computer networks (e.g., DRM 401-406; FIG. 4A). The encryption 455 plays a vital role in the security assurance of IT systems and communications as they can provide not only confidentiality, but also the following key elements of security:
Authentication: the origin of a message can be verified.
Integrity: proof that the contents of a message have not been changed since it was sent.
Non-repudiation: the sender of a message cannot deny sending the message.

Briefly, there is a subset of DRM's that use Common Encryption (CENC). CENC is designed to be interoperable, hence the name ‘common encryption’ so it uses only one form of encryption, notably AES-128 CTR. A notable difference between DRM's is the client key exchange with the license server. All non-CENC formats, for example Fairplay®, OMA™, Access®, and all proprietary schemes for PlayReady®, HLS (by for instance BuyDRM, Conax®, Discretix, Inside Secure®, Irdeto® or others), PIFF, PlayReady® for MPEG2-TS or other cannot be interchanged like the CENC ones and therefore can benefit from the trans DRM feature herein disclosed.

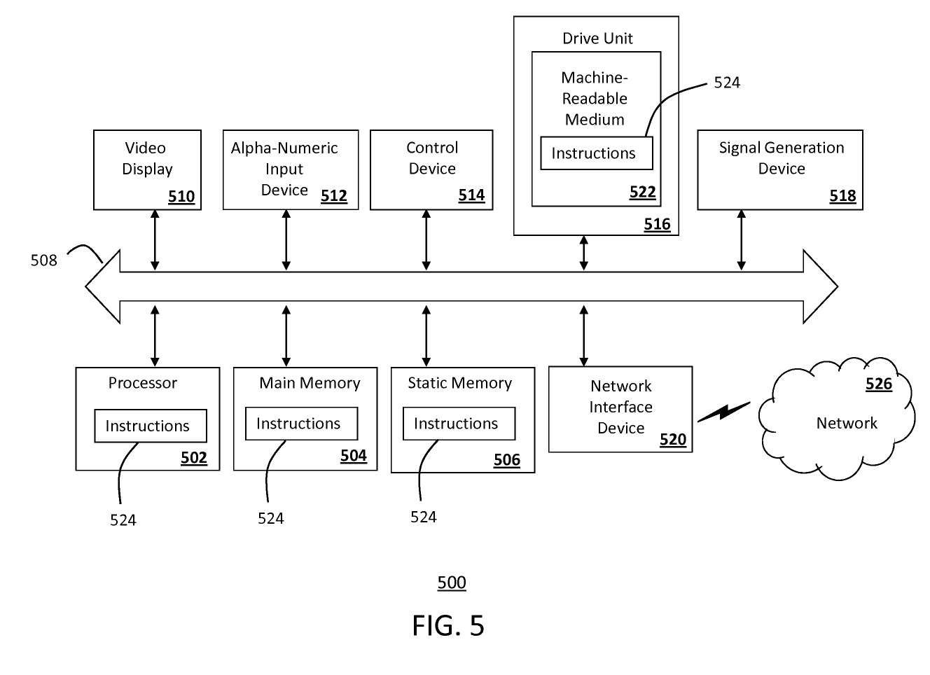

FIG. 5 depicts an exemplary diagrammatic representation of a machine in the form of a computer system 500 within which a set of instructions, when executed, may cause the machine to perform any one or more of the methodologies (or protocols) discussed above. This includes the methods disclosed in Appendices A-E; respectively, Unified Packager, Unified Video on Demand (VOD), Unified LIVE, Unified DRM (Unified VOD, Live and DRM comprising Unified Origin) and Unified Capture; all of which herein incorporated by reference in entirety. In some embodiments, the machine operates as a standalone device. In some embodiments, the machine may be connected (e.g., using a network 526) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, OLED). The computer system 500 may include an input device 512 (e.g., a keyboard), a control device 514 (e.g., a mouse), a mass storage medium 516, a signal generation device 518 (e.g., a speaker or remote control) and a network interface device 520.

The mass storage medium 516 may include a computer-readable storage medium 522 on which is stored one or more sets of instructions (e.g., software 524) embodying any one or more of the methodologies or functions described herein, including those methods illustrated above. The computer-readable storage medium 522 can be an electromechanical medium such as a common disk drive, or a mass storage medium with no moving parts such as Flash or like non-volatile memories. The instructions 524 may also reside, completely or at least partially, within the main memory 504, the static memory 506, and/or within the processor 502 during execution thereof by the computer system 500. The main memory 504 and the processor 502 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

For example, referring to FIG. 5B, the machine 500 can be included in part or whole, within, or communicatively coupled to, any of the system components shown (origin 110, viewer 130, or CMS 120). As an example, the Unified Packager, Unified Video on Demand (VOD), Unified LIVE, Unified DRM and/or the Unified Capture respectively disclosed in Appendices A-E of the provisional patent application herein incorporated by reference in its entirety, include software programmable instructions that can be implemented on machine 500 for performing any of the following steps disclosed herein, alone or in combination, and including any aspect of the following methods:

Where applicable, the present embodiments of the invention can be realized in hardware, software or a combination of hardware and software. Any kind of computer system or other apparatus adapted for carrying out the methods described herein are suitable. A typical combination of hardware and software can be a portable communications device with a computer program that, when being loaded and executed, can control the portable communications device such that it carries out the methods described herein. Portions of the present method and system may also be embedded in a computer program product, which comprises all the features enabling the implementation of the methods described herein and which when loaded in a computer system, is able to carry out these methods.

What is claimed is:

1. A method for trans-muxing media content into various consumption formats in a content delivery network, the method comprising the steps of:
reading a server manifest file comprising:
a key id and a content encryption key that authorize a re-encrypting of media content, and
at least one Digital Rights Management (DRM) setting identifying a source of media content;
dynamically re-encrypting the media content from the at least one DRM setting into one or more re-encrypted DRM formats; and
updating the server manifest file to identify a trans-mux support of the one or more re-encrypted DRM formats.

2. The method of claim 1, further comprising determining from the server manifest file locally or remotely available media formats that require trans-muxing in accordance with at least one of a bit-rate, packet size or timing requirement for streaming to a viewer requesting the media content.

3. The method of claim 1, further comprising
including an ismproxypass keyword to allow for a request to a Content Management System (CMS) that identifies a location of the server manifest; and
dynamically fetching the server manifest file from the Content Management System (CMS) responsive to the ismproxypass keyword,
where the fetching is dynamic due to a mapping created from the ismproxypass that fetches the server manifest from a location of the CMS as it is needed.

4. The method of claim 1, where the step of updating the server manifest file includes adding at least one DRM setting in the server manifest for streaming the media content in a re-encrypted DRM format, where the DRM setting comprises at least one of a KID and possibly a LA URL.

5. The method of claim 3, where the step of updating the server manifest file includes adding or removing one or more security keys and content related keys according to a rule implemented on a CMS,
where the rule comprises:
dynamically updating the server manifest to identify different DRM's listed in the server manifest to retrieve the encrypted content, or
dynamically updating the server manifest to indicate no DRMs are to be used thereby streaming media content in the clear without encryption.

6. The method of claim 4, further comprising
upon receiving a request from a viewer for the media content:
determining a media format supported by the viewer from the request;
inquiring the server manifest for the DRM setting that provides a trans-coded DRM format for the media format;
providing the key id and the content encryption key through the DRM setting for authentication and verification to the source of media content; and
streaming the media content in the re-encrypted DRM formats from the DRM setting to the viewer responsive to the verification.

7. The method of claim 1, where the media content is video on demand (VOD) residing on a disk (VOD) at the origin, or is ingested via streaming in a live manner.

8. The method of claim 1, where the server manifest, according to the security keys and content related keys, authorizes retrieval of the media content and formatting operations on the media content as required for preparing and streaming to a viewer requesting the media content, where the trans-mux support provides confidentiality, authentication, integrity and non-repudiation of the media content.

9. The method of claim 3, wherein the CMS replies with the server manifest containing i) a first key of a first DRM, and ii) encryption/decryption settings for the second DRM, thereby providing instruction to the origin in the server manifest for decrypting media content at the first DRM to produce media in the clear, and re-encypting the media in the clear to produce re-encrypted media stored at the second DRM.

10. A method to provide re-encrypting media performed by an origin in a content delivery network, the method comprising the steps of:
upon receiving a request from a viewer for a media content,
determining a media format supported by the viewer from the request for the media content;
inquiring a server manifest file for a trans-mux support of the media format, where the server manifest comprises:
a key id and a content encryption key for the media content for authorizing a re-encrypting of media content, and
at least one DRM setting identifying one or more re-encrypted DRM media that supports the media format requested; and
streaming the re-encrypted DRM media to the viewer.

11. The method of claim 10, where an origin, responding to the viewer for media content, dynamically fetches the server manifest from the CMS as it is needed by way of an ismproxypass mapping in a request to the CMS thereby allowing the CMS to control oversight and use of certificates, key and rights included or identified in the server manifest file for managing consumption of the media content.

12. The method of claim 10, where the origin dynamically fetches the server manifest file from a Content Management System (CMS),
where the at least one Digital Rights Management (DRM) setting comprises at least one among a query parameter, data type, and content link to fulfill the streaming of re-encrypted DRM media to the viewer,

13. The method of claim 10, further comprising:
updating the trans-mux support identified in the server manifest for the one or more re-encrypted DRM formats,
when the DRM media is a re-encryption of a de-crypted media content in a different DRM format.

14. The method of claim 13, where the trans-mux support includes:
retrieving the media content in a first DRM format identified in the server manifest;
decrypting the media content in the first DRM format to produce a media in the clear; and
re-encrypting the media in the clear to produce media content in a second DRM format, and
updating the server manifest with new DRM settings to identify the media content in the second DRM format.

15. The method of claim 14, further comprising:
updating the server manifest by adding, changing or removing DRM settings as configured by one or more business logic and rules,
where the DRM settings comprise at least one of a query parameter, data type, and content link for accessing or retrieving the media content.

16. The method of claim 14, including reading at least one key in the server manifest for authorized access to the media content, and performing the step of decrypting and re-encrypting with the at least one key.

17. The method of claim 16, including generating a new key for the step of re-encrypting the media in the clear and including the new key in the server manifest.

18. The method of claim 10, further comprising encapsulating a key identifier (KID) and a content key (CEK) in the server manifest file to permit authorized use of, or license to, the media content streamed to the viewer if originated locally or retrieved via the one or more DRM's.

19. The method of claim 10, wherein the server manifest file is
retrieved locally from an origin, or
dynamically fetched from a content management server (CMS).

20. The method of claim 19, wherein the CMS returns: i) an original key in the server manifest for the origin to perform the de-crypting, and ii) a new key according to a specification of a second DRM in the server manifest for the origin to perform the re-encrypting.
